(19) United States
(12) Patent Application Publication
(10) Pub. No.: US 2015/0217519 A1
(43) Pub. Date: Aug. 6, 2015

(54) Device for Forming a Workpiece by Means of 3-D Extrusion

(71) Applicant: Leapfrog B.V., Alphen aan den Rijn (NL)

(72) Inventor: Martinus Petrus Otten, Amsterdam (NL)

(21) Appl. No.: 14/613,695

(22) Filed: Feb. 4, 2015

(30) Foreign Application Priority Data
Feb. 4, 2014 (NL) 2012198

(51) Int. Cl. B29C 67/00

(52) U.S. Cl. CPC B29C 67/0088; B29C 67/0055; B33Y 10/00

(57) ABSTRACT

The invention relates to a device and a method for forming a workpiece by 3-D extrusion, wherein the device is provided with three vertical spindles drivable by spindle motors, a horizontal work platform for the workpiece connected to the spindles, wherein the vertical position of the work platform at the position of the spindles is adjustable by these spindles, a displacing member for horizontal displacement of an extrusion head and a control member for controlling the spindle motors, the displacing member and the extrusion head, wherein the device comprises a measuring device for measuring the vertical position of the work platform at the spindles and the control member is configured to move the work platform close to the extrusion head, to measure the vertical position of the work platform at each spindle and to correct the vertical position of the work platform by means of the spindle motors. The extrusion head thus always moves parallel to the work platform.

### CROSS-REFERENCE TO RELATED APPLICATION

This application claims priority to The Netherlands Patent Application No. 2012198 filed Feb. 4, 2014, the disclosure of which is hereby incorporated in its entirety by reference.

### BACKGROUND OF THE INVENTION

1. Field of the Invention

The use of 3-D extrusion for manufacturing workpieces has greatly increased in recent years. This relates not only to the manufacture of prototypes and models but also, as a result of the falling prices of this technique, the production of small series.

The invention therefore relates to a device for forming a workpiece by means of 3-D extrusion, wherein the device is provided with a frame, at least three spindles extending in vertical direction at three different positions in the frame and drivable by means of spindle motors, a substantially horizontally extending work platform for supporting the workpiece, wherein the work platform is connected to each of the spindles and wherein at the position where the work platform is connected to one of the spindles the vertical position of the work platform is adjustable by the associated spindle, a displacing member connected to the frame and configured to displace a carrier in a substantially horizontal plane of movement, at least one extrusion head mounted on the carrier, feed means for feeding material for extrusion to the at least one extrusion head and a control member for controlling the spindle motors, the displacing member, the extrusion head and the feed means.

2. Description of Related Art

Such devices are generally known. The application of 3-D printing requires a mobility of the extrusion head in three directions relative to the work platform, also referred to as a bed. In the above elucidated device the work platform is configured to move in the vertical direction and the extrusion head is configured to move in both horizontal directions.

It is of great importance for the manufacture of a workpiece with a high precision that the plane in which the extrusion head can move is as parallel as possible to the plane of the work platform. The digital model which moves the extrusion head does after all have layers which are built up during successive movements of the extrusion head formed in a plane. When the base surface is not precisely parallel to the plane in which the extrusion head moves, there is the chance of the extrusion head catching against the platform or against already formed layers or of the extruded material not making contact with a base surface. This is solved in the prior art by forming the lowermost layers of a workpiece from a removable, for instance water-soluble material as is also used in this technique to fill recesses. The application of such a material requires the use of a device with at least two extrusion heads and associated auxiliary equipment, while it is not possible to preclude the initially arranged layers of removable material forming a base layer which extends wholly parallel to the plane in which the extrusion head moves.

The present invention has for its object to provide a device of the above stated type which, also with use of a single extrusion head, avoids the above stated drawbacks.

### SUMMARY OF THE INVENTION

This object is achieved with a device of the above stated type, wherein the device is provided with a measuring device for measuring the vertical position of the work platform at measuring positions located in the vicinity of the spindles, and the control member is configured to move the work platform into the vicinity of the carrier, to measure the vertical position of the work platform in each of the measuring positions and to correct the vertical position of the work platform by means of the spindle motors so that the work platform extends parallel to the plane of movement of the carrier.

As a result of these measures the work platform is brought into a position wherein it extends parallel to the plane of movement of the extrusion head so that the layers of extruded material are built up in parallel layers.

There are various possibilities for implementing the invention. A first embodiment thus provides the option of mounting the measuring device on the frame in the form of at least three measuring members, each arranged in the vicinity of a spindle. This embodiment is based on the assumption that the frame forms the reference and that the plane in which the displacing member moves extends parallel to a reference plane of the frame. This embodiment makes use of measuring members which are mounted on the frame and the position of which is known relative to the reference plane of the frame and which measures, and where necessary corrects, the position of the work platform.

The above embodiment makes use of the assumption that the plane of movement of the extrusion heads extends parallel to the reference plane of the frame. This is not necessarily always the case. For situations in which this is indeed not the case, a further embodiment provides the measure that the measuring members are configured to measure the vertical position of the carrier in each of the measuring positions, and that the control member is configured to move the carrier to the successive measuring positions. When determining the plane of movement of the extrusion heads and when determining the plane of the work platform reference is thus made to the reference plane of the frame so that a possible misalignment of the plane of movement of the extrusion heads is compensated.

It is however also possible to operate without reference of the frame. Another embodiment provides for this purpose the measure that the carrier is provided with a measuring member for determining the height of the work platform relative to the carrier, and that the control member is configured to move the work platform into the vicinity of the carrier, to move the carrier to the successive measuring positions, to measure the vertical position of the work platform in each of the measuring positions by means of the measuring member and to correct the vertical position of the work platform by means of the spindle motors so that the work platform extends parallel to the plane of the movement of the carrier. In this embodiment a measurement is thus carried out between the components of the device which in fact determine the accuracy.

According to a first structurally attractive embodiment, the measuring member is provided with a pin movable in vertical direction in a guide and with a detector which generates a signal when the pen reaches a predetermined position during the upward movement thereof relative to the guide. This is a simple, reliable and accurate manner of measuring the associated distance.

It is not however precluded according to an alternative embodiment that the measuring member comprises a distance meter operating by means of laser. Laser-based measuring members are becoming available at increasingly lower prices in recent times, so that this form of distance meter forms a good alternative.

In order to increase the accuracy of the measurement procedure, it is recommended that the control member is configured to correct the vertical position of the work platform prior to the manufacture of a product. The calibration is hereby carried out shortly before the moment at which accuracy is of the greatest importance.

According to a structurally attractive embodiment, the displacing member comprises a first and a second primary guide rail, both extending substantially horizontally on either side of the space defined by the spindles, a carriage which extends between the primary guide rails and is movable along the primary guide rails and which is provided with a secondary guide rail which extends transversely of the primary guide rails and along which the carrier is movable, and drive means for moving the carriage along the primary guide rails and moving the carrier along the secondary rails. This construction makes it possible to arrange the measuring member on the underside of the carrier.

Yet another structurally attractive embodiment provides the measure that the drive means comprise a primary motor which is placed in the frame and coupled to a primary toothed wheel which is connected by means of a primary toothed belt to the carriage, and comprise a secondary motor placed in the frame and coupled to a secondary toothed wheel which is connected by means of a secondary toothed belt to the carrier. This method of driving the carrier results in a low mass inertia since the motors are both mounted fixedly in the frame and these relatively heavy parts do not need to be moved.

The invention finally provides a method for placing parallel to the plane of movement of an extrusion head of a 3-D extrusion machine a work platform which is movable in vertical direction by means of spindles and on which the workpiece to be manufactured by the extrusion machine is formed, comprising the steps of moving the work platform into the vicinity of a carrier on which the extrusion head is placed, moving the carrier to successive measuring positions in the vicinity of the spindles, measuring the vertical position of the work platform in each of the measuring positions and correcting the vertical position of the work platform by means of the spindles. Application of this method results in the same advantages as the use of the above elucidated devices.

### BRIEF DESCRIPTION OF THE DRAWINGS

The present invention is elucidated hereinbelow with reference to the accompanying drawings, in which:

FIG. 1 is a schematic front view of a device according to the invention;

FIG. 2 is a schematic perspective view of the device shown in FIG. 1; and

FIG. 3 is a schematic cross-sectional view of an alternative embodiment.

### DETAILED DESCRIPTION OF THE INVENTION

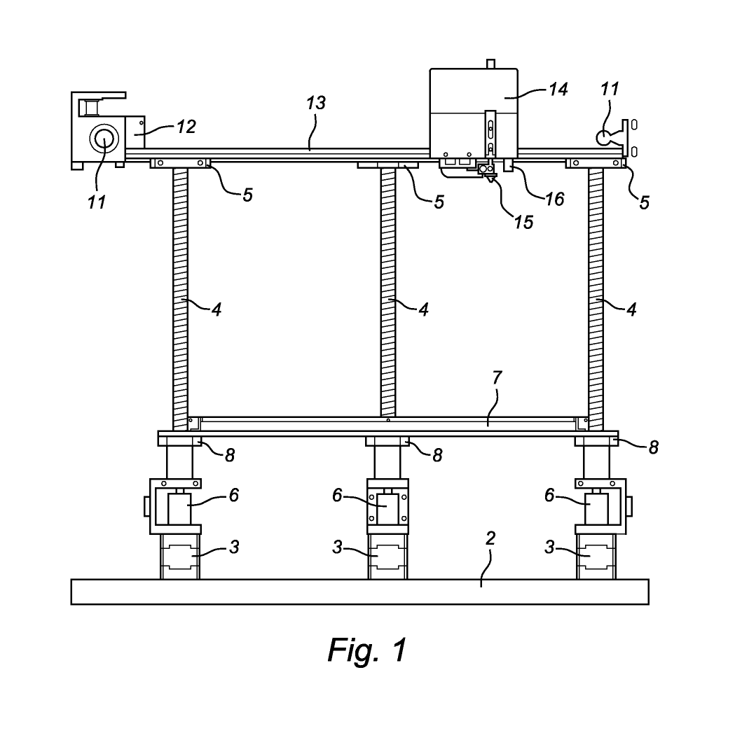

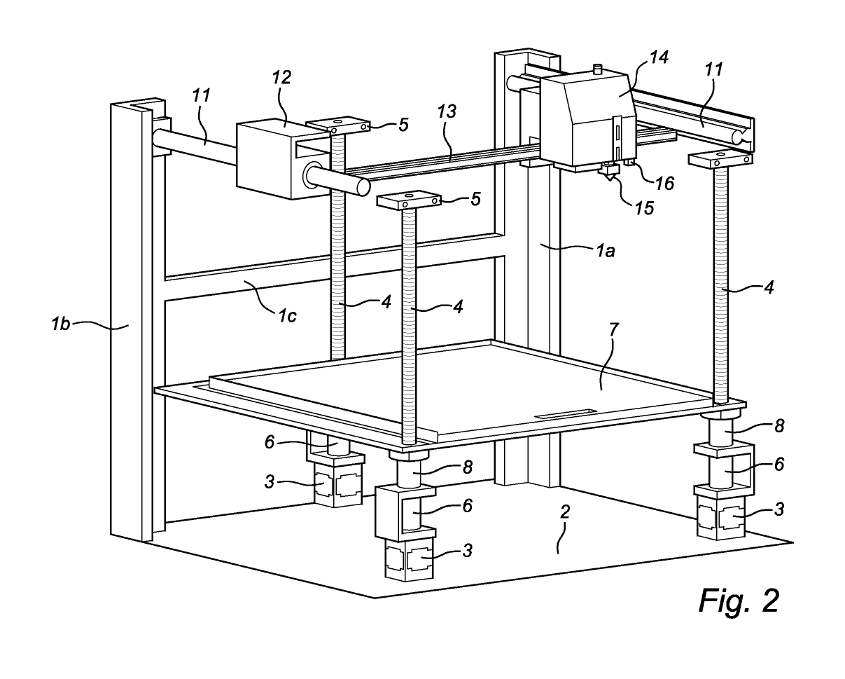

The device shown in FIGS. 1 and 2 comprises a frame 1 which is shown in FIG. 2 in the form of two vertical angle profiles 1a and 1b and a rod 1c connecting the two profiles. It will be apparent that the frame will be provided in most cases with corresponding angle profiles on the front side of the device. It is however likewise possible for the frame to take the form of a casing in which the components are placed. Frame 1 also comprises a base plate 2 on which, in the present case at each of two corner points and in the middle of the opposite side, is placed a foot 3 in which is mounted a vertically extending spindle 4. On their upper side the spindles 4 are each mounted in an upper bearing 5 connected to frame 1. Arranged in each of the feet 3 is an electric motor 6 which functions as spindle motor and can drive the associated spindle 4 in rotation. A gear transmission can be arranged in the housing of spindle motor 6. Arranged above base plate 2 is a work platform 7 which extends as horizontally as possible. Work platform 7 is connected to three nuts 8 through which spindles 4 extend and to which they are connected. When one of the motors 6 is thus running, the spindle 4 connected thereto will rotate whereby the nut 8 placed thereon moves in vertical direction and work platform 7 is adjusted in height at the position of nut 8 which will tilt work platform 7. With synchronous use of the three spindle motors 6 the work platform 7 will be moved as a whole in vertical direction.

For the purpose of arranging the extruded material use is made of a displacing member which is designated as a whole with 10 and which is provided with two primary guide rails 11 extending horizontally and mutually parallel in the vicinity of the upper end of frame 1. Arranged between these guide rails 11 is a carriage 12 which is movable along primary guide rails 11 in the longitudinal direction of primary guide rails 11. Arranged in the longitudinal direction of carriage 12 is a secondary guide rail 13 along which a carrier 14 is movable. Carrier 14 is provided on its underside with an extrusion head 15.

Owing to the combined movement of carriage 12 along primary guide rails 11 and of carrier 14 along secondary guide rail 15 the extrusion head 15 can be moved over the whole surface of work platform 7. For driving of carriage 12 along primary guide rails 11 use is made of an electric motor (not shown in the drawings) which is connected fixedly to the frame and connected to carriage 12 by means of a toothed wheel (not shown) and toothed belt (not shown). For driving of carrier 14 along secondary guide rail 13 use is made of an electric motor (not shown in the drawing) which is connected to carrier 14 by means of a toothed wheel and a toothed belt. This toothed belt is guided in two directions along the carriage in order to separate the movement of carrier 14 from that of carriage 12. The device is of course provided with a control device in the form of a digital computer for the purpose of controlling diverse electric motors and the extrusion head so that the desired product is formed. It will be apparent to the skilled person that means are also provided for feeding the material for extrusion to the extrusion head, as known per se from the prior art. The device described up to this point corresponds to a prior art device.

In order to achieve the effect of the invention the carrier 14 in the embodiment shown in FIGS. 1 and 2 is provided on its underside with a probe 16 functioning as measuring member. This probe 16 is connected to the digital computer which is configured to perform the following procedure.

Prior to the production of a new product, or at any other desired moment, work platform 7 is carried to a position in the vicinity of carrier 14. In many cases this will be the uppermost position of work platform 7. Carrier 14 is then moved to a position in the vicinity of one of the spindles 4 and the distance between carrier 14 and the work platform is measured at this position by means of the probe 16 mounted on the underside of carrier 14. This measurement is repeated in the vicinity of the other spindles 4. Information is hereby obtained relating to the possible misalignment of work platform 7 relative to the plane in which carrier 14, and thereby extrusion head 15, moves. Finally, the control member controls spindle motors 6 such that work platform 7 extends parallel to the plane of movement of carrier 14. The product can then be manufactured, wherein work platform 7 continues to extend parallel to the plane of movement of carrier 14 through appropriate control of spindle motors 6.

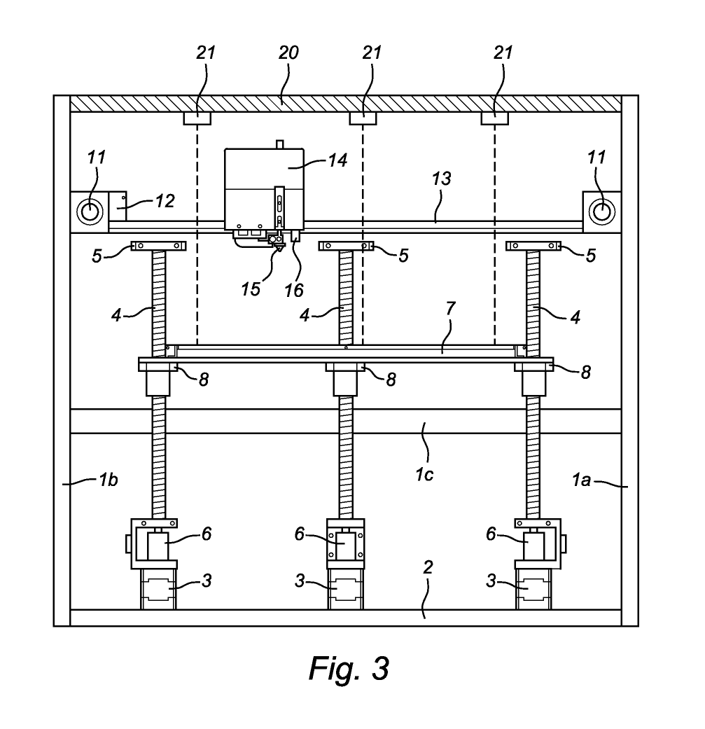

FIG. 3 shows an embodiment wherein the frame is provided with an upper plate 20, on the underside of which three distance measuring members 21 are provided, only two of which are shown in the drawing. These distance measuring members 21 are configured to measure the distance between the associated measuring member 21 and work platform 7 under the control of the digital computer. It is then also possible for the digital computer to align work platform 7 parallel to upper plate 20 by means of controlling the spindle motors 6. This embodiment is based on the assumption that the plane of movement of carrier 14 extends parallel to upper plate 20, which will indeed generally be the case. It is however also possible to measure the position of carrier 14 in the three associated positions in the vicinity of spindles 4 by means of measuring members 21, wherein a possible misalignment of upper plate 20 relative to the plane of movement of carrier 14 is compensated.

It will be apparent that diverse variations can be applied in the above stated embodiments within the scope of the invention as defined by the appended claim.

Measures of different embodiments can in particular be combined with each other. It is also pointed out that the embodiments have three spindles, but that the invention is likewise applicable with two, four or more spindles. It is possible to make use of other controllable vertical displacing means instead of spindles.

1. A device for forming a workpiece by means of 3-D extrusion, wherein the device comprises:
a frame;
at least three spindles extending in vertical direction at three different positions in the frame and drivable by means of spindle motors;
a substantially horizontally extending work platform for supporting the workpiece, wherein the work platform is connected to each of the spindles and wherein at the position where the work platform is connected to one of the spindles the vertical position of the work platform is adjustable by the associated spindle;
a displacing member connected to the frame and configured to displace a carrier in a substantially horizontal plane of movement;
at least one extrusion head mounted on the carrier;
feed means for feeding material for extrusion to the at least one extrusion head; and
a control member for controlling the spindle motors, the displacing member, the extrusion head and the feed means,
wherein
the device is provided with a measuring device for measuring the vertical position of the work platform at measuring positions located in the vicinity of the spindles;
the control member is configured to move the work platform into the vicinity of the carrier, to measure the vertical position of the work platform in each of the measuring positions and to correct the vertical position of the work platform by means of the spindle motors so that the work platform extends parallel to the plane of movement of the carrier.

2. The device as claimed in claim 1, wherein the measuring device is mounted on the frame and is provided with at least three measuring members, each arranged in the vicinity of a spindle.

3. The device as claimed in claim 2, wherein the measuring members are configured to measure the vertical position of the carrier in each of the measuring positions, and that the control member is configured to move the carrier to the successive measuring positions.

4. The device as claimed in claim 1, wherein
the carrier is provided with a measuring member for determining the height of the work platform relative to the carrier;
the control member is configured to move the work platform into the vicinity of the carrier, to move the carrier to the successive measuring positions, to measure the vertical position of the work platform in each of the measuring positions by means of the measuring member and to correct the vertical position of the work platform by means of the spindle motors so that the work platform extends parallel to the plane of the movement of the carrier.

5. The device as claimed in claim 4, wherein the measuring member is provided with a pin movable in vertical direction in a guide and with a detector which generates a signal when the pen reaches a predetermined position during the upward movement thereof relative to the guide.

6. The device as claimed in claim 4, wherein the measuring member comprises a distance meter operating by means of laser.

7. The device as claimed in claim 1, wherein the control member is configured to correct the vertical position of the work platform prior to the manufacture of a product.

8. The device as claimed in claim 1, wherein the displacing member comprises:
a first and a second primary guide rail, both extending substantially horizontally on either side of the space defined by the spindles;
a carriage which extends between the primary guide rails and is movable along the primary guide rails and which is provided with a secondary guide rail which extends transversely of the primary guide rails and along which the carrier is movable; and
drive means for moving the carriage along the primary guide rails and moving the carrier along the secondary rails.

9. The device as claimed in claim 8, wherein the drive means comprise a primary motor which is placed in the frame and coupled to a primary toothed wheel which is connected by means of a primary toothed belt to the carriage, and comprise a secondary motor placed in the frame and coupled to a secondary toothed wheel which is connected by means of a secondary toothed belt to the carrier.

10. A method for placing parallel to the plane of movement of an extrusion head of a 3-D extrusion machine a work platform which is movable in vertical direction by means of spindles and on which the workpiece to be manufactured by the extrusion machine is formed, comprising the following steps of:
moving the work platform into the vicinity of a carrier on which the extrusion head is placed,
moving the carrier to successive measuring positions in the vicinity of the spindles, measuring the vertical position of the work platform in each of the measuring positions and correcting the vertical position of the work platform by means of the spindles.
